(19) United States
(12) Patent Application Publication
(10) Pub. No.: US 2006/0081026 A1
(43) Pub. Date: Apr. 20, 2006

(54) Lock structure having multiple anti-theft measures

(75) Inventor: Yuan-Ching Lin, Banciao City (TW)

Correspondence Address: Yuan-Ching Lin, P. O. Box No. 6-57, Junghe, Taipei, 235, TW

(73) Assignees: Yuan-Ching LIN, Banciao City (TW); Shih-Shien YANG, Banciao City (TW)

(21) Appl. No.: 10/965,759

(22) Filed: Oct. 18, 2004

(51) Int. Cl. E05B 27/08

(52) U.S. Cl. 70/491

(57) ABSTRACT

A lock structure having multiple anti-theft measures includes a lock body, a key and an electronic anti-theft device. The invention is characterized that, the lock body has an inner tube internally disposed with three spring pegs having different lengths and two lock cylinder pegs; outer walls of the spring pegs are disposed with protruding posts for corresponding with depths of grooves at a front end of the key; the lock cylinder pegs are connected with a central lock cylinder; rear ends of the five pegs are all connected with the electronic anti-theft device; and a long needle and a middle needle projecting from a front end of the key are supported against the lock cylinder. Using the structure, when the key having an exact length is inserted in an appropriate direction into the lock body, the lock structure is successfully unlocked without triggering the electronic anti-theft device.

### BACKGROUND OF THE INVENTION

(a) Field of the Invention

The invention relates to a lock structure having multiple anti-theft measures suitable for automobiles, doors and other objects ensuring confidentiality, and more particularly, to a lock structure having multiple anti-theft measures, in that the lock structure having multiple anti-theft measures comprising a lock body and an electronic anti-theft device.

(b) Description of the Prior Art

Common households, automobiles, and various vaults and safety boxes, are installed with a diversity of lock structures. In addition, different anti-theft devices are provided to ensure household safety, automobile security, information confidentiality and treasure safety. From comprehensive survey, available lock structures include bearing locks, plate locks and locks with distinct structures, and all these lock structures have different unlocking principles. In general, bearing locks are more extensively applied to ordinary door locks and hook locks, and plate locks are implemented to drawer locks, mailbox locks, vault locks and automobile door locks. There is a five-sectional lock structure offering even better anti-theft effects. However, thieves often adopt damaging means for theft crimes, and likely target at older locks having design disadvantages. As a method for automobile theft mostly commonly seized by the police, all kinds of destruction tools such as wrenches, screwdrivers, or universal keys are utilized, and even power supplies of locks are destroyed in order to proceed with automobile theft. Later, a key using a magnet design has become available. Yet, such key has a major shortcoming of being incapable of unlocking functions once magnetic forces diminish or disappear. It is to be noted that, magnets are prone to attach dusts while also being unsatisfactorily heat-resistant. Supposed a magnetic key is left in an automobile and demagnetized by high heat from the sun, it is only very possible that the key can no longer be used. Hence, with consideration of lifespan, such keys are less applied. When a good set of lock structure is installed, it does not always fit into the circumstance. It is observed from many theft scenes that, thieves always select lock structures having simpler structures. The more the number of locks, the longer it delays thieves to unlock, and thus the more protection is offered. As a conclusion, lock structures with more anti-theft designs are unlikely become targets of thieves. In the view of the aforesaid shortcomings of prior art, it is a vital task of the invention as how to provide a lock structure having multiple anti-theft measures, in that the lock structure uses adjustable structures thereof and an anti-theft system connected to a rear section thereof to accomplish anti-theft and anti-destruction purposes.

### SUMMARY OF THE INVENTION

The primary object of the invention is to provide a lock structure having multiple anti-theft measures.

To accomplish the aforesaid object, a lock structure having multiple anti-theft measures comprises a lock body, a key and an electronic lock device. The lock body has an inner tube, which is provided with a five-blossom-like opening at a center section thereof. Auxiliary openings of the five-blossom-like opening are installed with three spring pegs having different lengths and two lock cylinder pegs. The lock cylinder pegs are connected with a central lock cylinder. Each of the five pegs is provided with a protruding post at outer walls thereof, wherein all the protruding posts are located at different positions and are corresponding to depths of five grooves at a front end of the key. Each of the five pegs is has a rear end thereof accommodated by a spring, using which front ends of the pegs are inserted into stop openings at a front section of a cover of the main body. Rear ends of the pegs are positioned at a round locating block, which has a size thereof corresponding to an opening at a rear end of the inner tube. The inner tubes has side thereof disposed with locating pin openings of locating pins and bearing openings for assisting sliding movements of the key. In addition, lengths of a long needle and a middle needle in the key are adjustable according to requirements using screw threads and springs at various internal parts. A locating opening at a rear end of the outer tube of the lock body is installed with an electricity connecting block connected to the electronic anti-theft device.

To put the aforesaid structure to use, the key is inserted into the lock body in an appropriate direction, such that the depths of the grooves at outer sides at the front end of the key are exactly fastened with the protruding posts at the pegs, thereby preventing the five pegs from being disengaged by pushing forces. Furthermore, without contacting and triggering the electronic anti-theft device, the inner tube of the lock body is smoothly turned to unlock the lock structure. For default settings of the lock structure, the lock cylinder of the lock body is first positioned at the rear end of the inner tube, and the two connected lock cylinder pegs are located at appropriate positions. The lengths of the internal long needle and middle needle are then adjusted, so that, without producing relative movements that can displace the lock cylinder pegs connected to the two ends of the lock cylinder, these lengths are exactly supported against the lock cylinder when the key is inserted in an appropriate direction into the inner tube of the lock body to unlock. At the same time, using correspondence of the protruding posts of the five pegs with the grooves at the front end of the key, relative movements that contact the round locating blocks at the rear end of the pegs with the electricity connecting block are not produced, thereby unlocking the lock body by turning the inner tube without triggering the electronic anti-theft device. Moreover, apart from providing connection with users and serving as a reporting system of police departments using wireless communication, the electronic anti-theft device is combined with various sensors such as temperature and impact sensors, such that the wireless communication device is directly activated when the lock structure encounters damages by high temperatures or impacts to notify users and reporting systems of police departments. It is apparent from the above descriptions that, the lock structure uses internal configurations of a lock body thereof, an especially design key and an electronic anti-theft device at a rear end, thereby accomplishing multiple anti-theft effects.

### BRIEF DESCRIPTION OF THE DRAWINGS

FIG. 1 shows an exploded view according to the invention.

FIG. 2 shows a side sectional view according to the invention in assembly.

FIG. 3A shows a sectional view of the lock body in assembly according to the invention.

FIG. 3B shows a sectional view of the key in assembly according to the invention.

### DETAILED DESCRIPTION OF THE PREFERRED EMBODIMENTS

To better understand structures, devices and characteristics of the invention, detailed descriptions shall be given with a preferred embodiment according to the invention below.

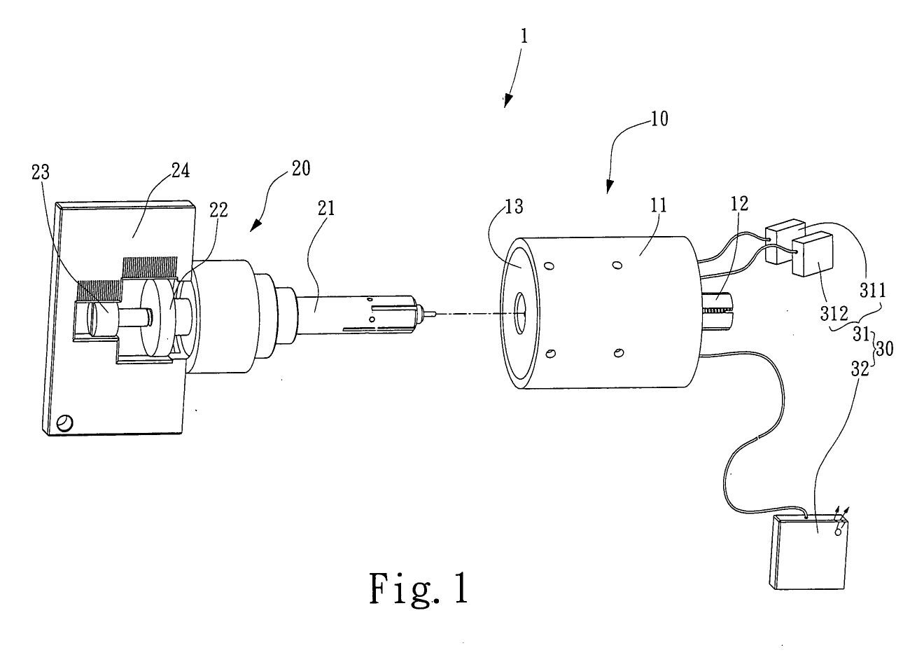

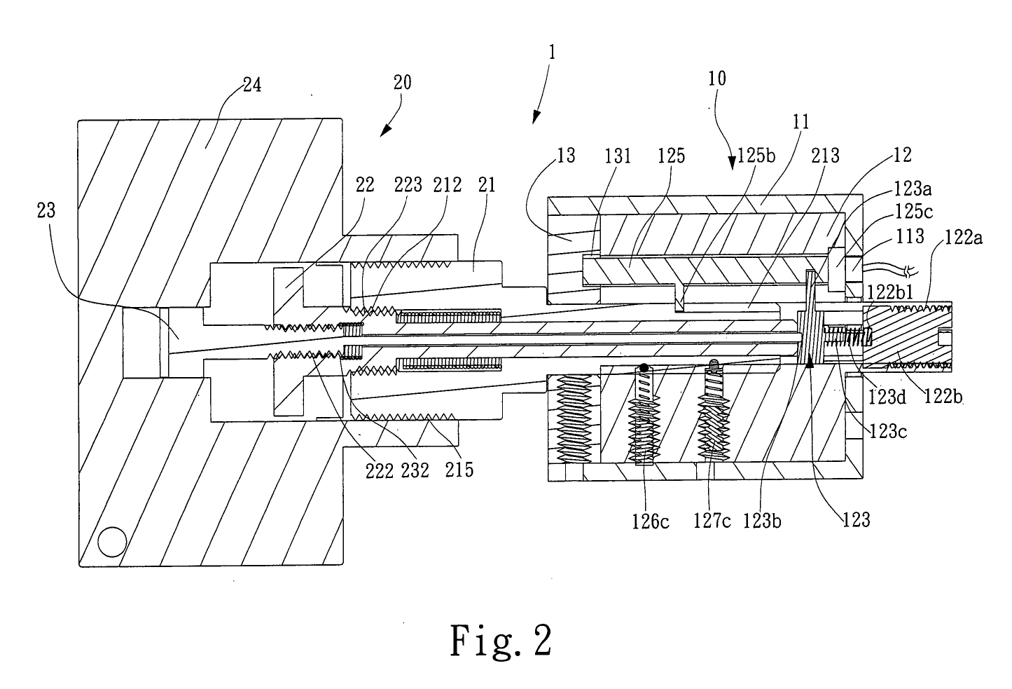

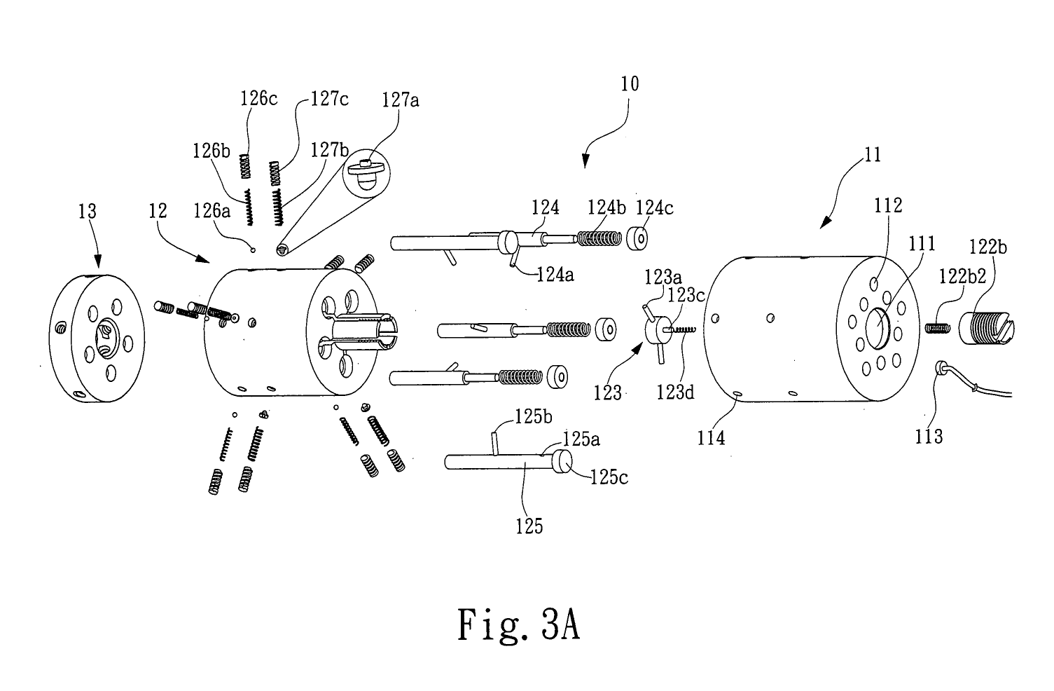

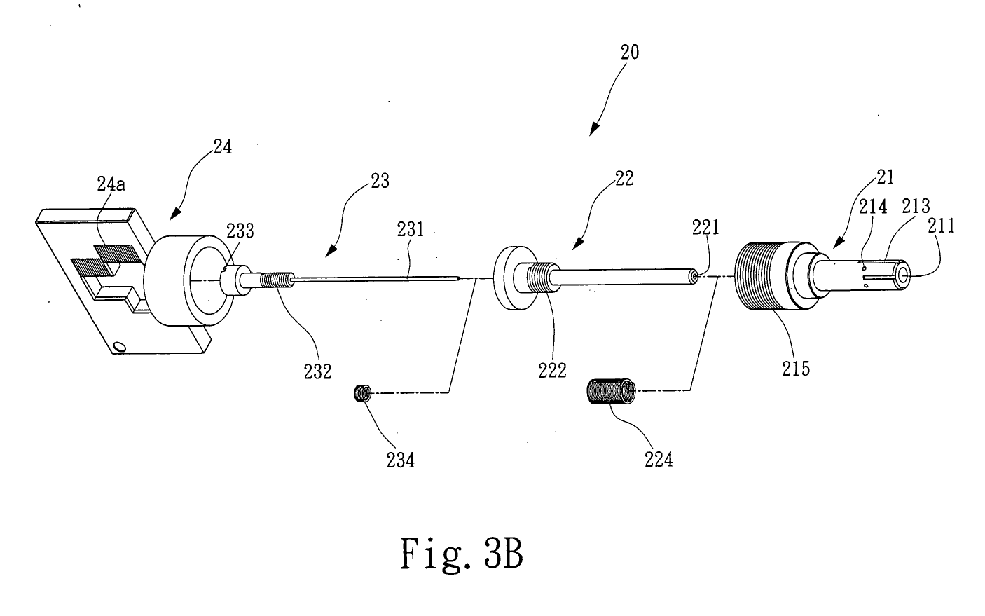

Referring to FIGS. 1, 2, 3A and 3B, a lock structure having multiple anti-theft measures 1 comprises a lock body 10, a key 20 and an electronic anti-theft device 30.

The lock body 10 has an outer tube 11, an inner tube 12 and a cover 13. The outer tube 11 is provided with a through opening 111 at a rear center section thereof, and two sets of five round locating openings 112 axially distributed at sides of the through opening 111. One set of the round locating openings 112 is used for locating an electricity connecting block 113, and the other set is for locating the lock body 10. The outer tube 11 is further provided with five locating openings 114 at outer walls of a front end thereof. The inner tube 12 is disposed with a five-blossom-like opening 121 at a center section thereof, and a protruding section 122 at a rear end thereof. The protruding section 122 has a screw thread 122a at an inner periphery thereof, and a supporting block 122b accommodated therein by screwing means. The supporting block 122b is for locating a position of a lock cylinder 123, and has an indentation 122b1 at a front end thereof and installed with a spring 122b2. The lock cylinder 123 has a size corresponding to an inner diameter of the protruding section 122; and is provided with two supporting pins 123a at outer walls thereof, a recess 123b at a front center section thereof, a projecting column 123c at a rear center thereof, and a spring 123d accommodated around the projecting column 123c. The five-blossom-like opening 121 is disposed with three spring pegs 124 and two lock cylinder pegs 125. Each of the two lock cylinder pegs 125 is provided with an opening 125a for inserting supporting pins 123a of the lock cylinder 123 therein for connecting purposes. Outer walls of each of the spring pegs 124 and the lock cylinder pegs 125 are provided with protruding posts 124a and 125b. The protruding posts 124a and 125b of all the spring pegs 124 and lock cylinder pegs 125 are located in different positions. Rear ends of each of the spring pegs 124 and lock cylinder pegs 125 are accommodated with springs 124b. Each of the spring pegs 124 and the lock cylinder pegs 125 is accommodated locating blocks 124c and 125c. Dimensions of the round locating blocks 124c and 125c are corresponding to diameters of locating openings 121a at a rear end of the five-blossom-like opening 121. The inner tube 12 has outer walls thereof disposed with five bearing openings 126 corresponding to the internal five-blossom-like opening 121. Each of the bearing openings 126 is placed with a bearing 126a, a spring 126b and a fastening bolt 126c. The bearings 126a are projecting from inner walls of the five-blossom-like opening 121, so as to assist in sliding movements of the key 20. At appropriate positions, the inner tube 12 further has inner walls at a rear end thereof provided with five locating pin openings 127. Each of the locating pin openings 127 is placed with a locating pin 127a, a spring 127b and a fastening bolt 127c. Front ends of the locating pins 127a are projecting from the inner walls of the five-blossom-like opening 121. The cover 13 is for sealing an opening at a front end of the inner tube 12 when the inner tube 12 is accommodated in the outer tube 11. A size of the cover 13 is corresponding to an inner diameter of the outer tube 11. The cover 13 has an obverse side thereof provided with five stopped openings 131 for corresponding to positions of the five pegs 124 and 125. Using the springs 124b and 125c at rear ends of the pegs 124 and 125, front ends of the pegs 124 and 125 are butted into the stopped openings 131. The cover 13 further has outer walls thereof provided with locating openings 132 corresponding to the locating openings 114 of the outer tube 11.

The key 20 is consisted of a main body 21 respectively penetrated by a middle needle 22 and a long needle 23. The main body 21 has a though opening 211 at a center section thereof, wherein a rear end of the through opening 211 is provided with a screw thread 212; five grooves 213 axially distributed and having unequal lengths at outer walls at a front end thereof; five semi-spherical holes 214 between the grooves 213; and screw threads 215 at lower sections of the grooves 213. The middle needle 22 has a through opening 221 at a center section thereof, wherein a rear end of the through opening 221 is provided with a screw thread 222; a screw thread 223 at a lower section at a front end thereof for corresponding with a rear end of the main body 21; and a spring 224 accommodated around the screw thread 223. The long needle 23 is provided with a long needle section 231 at a front end thereof; a screw thread 232 at a lower section thereof for corresponding with a rear end of the middle needle 32; an adjustment section 233 at a rear section thereof; and a spring 234 accommodated around a front end of the screw thread 232. The key 20 is further installed with a plastic protection cover 24 at a rear end thereof for covering rear ends of the middle needle 22 and the long needle 23. The plastic protection cover 24 has scales 24a for adjusting lengths of the middle needle 22 and the long needle 23.

The electronic anti-theft device 30 installed to the rear end of the lock body 10 has a plurality of sensors 31 and a wireless communication device 32. Each of the sensors 31 has a temperature sensor 311 and an impact sensor 312. The wireless communication device 32 is connected to the electricity connecting block 113, and is capable of contacting a user and notifying a report system of the police department.

Conclusive from the above, the loc structure having multiple anti-theft measures comprising the lock body, key and electronic anti-theft device, is complicated in structure for effectively intimidating thieves. In addition, the electronic anti-theft device having the sensors and wireless communication device offer auto-notification effects as well as being damage resistant. It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A lock structure having multiple anti-theft measures comprising a lock body and a key; and
being characterized that, the lock body has an inner tube internally disposed with three spring pegs having different lengths and two lock cylinder pegs; outer walls of each of the spring pegs is provided with a protruding post corresponding depth of grooves at a front end of the key; the lock cylinder pegs are connected to a central lock cylinder; rear ends of the five pegs are connected to an electronic anti-theft device; and long needle and middle needle projecting from a front end of the key are for supporting against the lock cylinder.

2. The lock structure having multiple anti-theft measures in accordance with claim 1, wherein the lock body has an outer tube, an inner tube and a cover; wherein,
the outer tube is a tubular body is provided with a through opening at a reverse center section thereof, two sets of five round locating openings axially distributed at sides of the through opening and for locating an electricity connecting block, and five locating openings at outer walls of a front end thereof;
the inner tube is disposed with a five-blossom-like opening at a center section thereof, and a protruding section at a rear end thereof; the protruding section has a screw thread at an inner periphery thereof, and a supporting block accommodated therein by screwing means; the supporting block is for locating a position of a lock cylinder; the lock cylinder has a size corresponding to an inner diameter of the protruding section, and is provided with two supporting pins at outer walls thereof, a recess at a front center section thereof, a projecting column at a rear center thereof, and a spring accommodated around the projecting column; the five-blossom-like opening is further disposed with three spring pegs and two lock cylinder pegs; each of the two lock cylinder pegs is provided with an opening at a side thereof for inserting supporting pins of the lock cylinder therein for connecting purposes; outer walls of each of the spring pegs and the lock cylinder pegs are provided with protruding posts; the protruding posts of all the spring pegs and lock cylinder pegs are located in different positions; rear ends of each of the spring pegs and lock cylinder pegs are accommodated with springs; dimensions of round locating blocks are corresponding to a diameter of locating openings at a rear end of the five-blossom-like opening; the inner tube has outer walls thereof disposed with five bearing openings corresponding to the internal five-blossom-like opening; each of the bearing openings is placed with a bearing, a spring and a fastening bolt; the bearings are projecting from inner walls of the five-blossom-like opening, so as to assist in sliding movements of the key; at appropriate positions, the inner tube further has inner walls at a rear end thereof provided with five locating pin openings; each of the locating pin openings is placed with a locating pin, a spring and a fastening bolt; and front ends of the locating pins are projecting from the inner walls of the five-blossom-like opening; and
the cover is for sealing an opening at a front end of the inner tube when the inner tube is accommodated in the outer tube; a size of the cover is corresponding to an inner diameter of the outer tube; the cover has an obverse side thereof provided with five stopped openings for corresponding to positions of the five pegs; using the springs at rear ends of the pegs, front ends of the pegs are butted into the stopped openings; and the cover further has outer walls thereof provided with locating openings corresponding to the locating openings of the outer tube.

3. The lock structure having multiple anti-theft measures in accordance with claim 1, wherein the key is consisted of a main body respectively penetrated by a middle needle and a long needle; the main body has a through opening at a center section thereof and a rear end of the through opening is provided with a screw thread, five grooves axially distributed and having unequal lengths at outer walls at a front end thereof, five semi-spherical holes between the grooves, and screw threads at lower sections of the grooves; the middle needle has a through opening at a center section thereof, and a screw thread at a rear section of the through opening, and a screw thread at a front lower section thereof for corresponding with a rear end of the main body; and the long needle is a long needle structure having a screw thread at a lower section thereof for corresponding with a rear end of the middle needle, and an adjustment section at a rear section thereof.

4. The lock structure having multiple anti-theft measures in accordance with claim 1, wherein the electronic anti-theft device has a plurality of sensors and a wireless communication device.

5. The lock structure having multiple anti-theft measures in accordance with claim 1, wherein two connecting terminals of the wireless communication device are connected to rear ends of the spring pegs of the lock cylinder.

6. The lock structure having multiple anti-theft measures in accordance with claim 1, wherein the wireless communication device is for contact users or serving as a reporting system of police departments.

7. The lock structure having multiple anti-theft measures in accordance with claim 1, wherein the screw thread at the lower section of the middle needle of the key is accommodated with a spring.

8. The lock structure having multiple anti-theft measures in accordance with claim 3, wherein the screw thread at the lower section of the middle needle of the key is accommodated with a spring.

9. The lock structure having multiple anti-theft measures in accordance with claim 1, wherein the screw thread at the lower section of the long needle of the key is accommodated with a spring.

10. The lock structure having multiple anti-theft measures in accordance with claim 3, wherein the screw thread at the lower section of the long needle of the key is accommodated with a spring.

11. The lock structure having multiple anti-theft measures in accordance with claim 1, wherein the key is installed has a rear section thereof installed with a plastic protection cover, which is for covering rear ends of the middle needle and the long needle, and is provided with scales.

12. The lock structure having multiple anti-theft measures in accordance with claim 3, wherein the key is installed has a rear section thereof installed with a plastic protection cover, which is for covering rear ends of the middle needle and the long needle, and is provided with scales.

13. The lock structure having multiple anti-theft measures in accordance with claim 1, wherein the electronic sensors of the anti-theft device are temperature sensors.

14. The lock structure having multiple anti-theft measures in accordance with claim 4, wherein the electronic sensors of the anti-theft device are temperature sensors.

15. The lock structure having multiple anti-theft measures in accordance with claim 1, wherein the electronic sensors of the anti-theft device are impact sensors.

16. The lock structure having multiple anti-theft measures in accordance with claim 4, wherein the electronic sensors of the anti-theft device are impact sensors.
